(19) United States
(12) Patent Application Publication
(10) Pub. No.: US 2005/0278397 A1
(43) Pub. Date: Dec. 15, 2005

(54) Method and apparatus for automated redundant data storage of data files maintained in diverse file infrastructures

(76) Inventor: Kevin J. Clark, Dorset (GB)

Correspondence Address: CHARLES A. RATTNER, 12 HOMEWOOD LANE, DARRIEN, CT, 06820-6109, US

(21) Appl. No.: 10/858,749

(22) Filed: Jun. 2, 2004

(51) Int. Cl. G06F 7/00

(52) U.S. Cl. 707/204

(57) ABSTRACT

A backup and recovery maintenance process useful, for example, in enterprise network systems having diverse application and data storage formats is disclosed. The process implements batch backup and recovery routines, in which critical backup files are generated and stored in accordance with standardized naming conventions. The process continuously monitors scheduled backup routines that each may be automatically performed at various intervals across the network, including traditional end-of-day backups, and further conducts integrity checks and housekeeping of stored backup files and transaction logs.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO COMPUTER PROGRAM LISTING APPENDIX

The present application includes a computer program listing appendix on two duplicate compact discs (labeled “Copy 1” and “Copy 2,” respectively) that are submitted herewith. Each compact disc includes thirty-eight text files (each created on May 8, 2004) in American Standard Code for Information Interchange (ASCII) format. The text files, listed by file name and file size (in bytes), are as follows: routine.bat.txt (14,194); routparm.bat.txt (1,606); routtran.bat.txt (10,091); routdel.bat.txt (1,066); routload.bat.txt (6,814); routpars.bat.txt (1,829); routapp.bat.txt (718); routcon2.bat.txt (979); routerr.bat.txt (1073); routren.bat.txt (973); dsp_routine_arcserve.sql.txt (1,288); dsp_routine_backdbcc.sql.txt (13,232); dsp_routine_backlog.sql.txt (5,914); dsp_routine_chkforzips.sql.txt (1,941); dsp_routine_chkpsteod.sql.txt (1,568); dsp_routine_copyfiles.sql.txt (6,384); dsp_routine_dbackeod.sql.txt (2,922); dsp_routine_dblist.sql.txt (3,912); dsp_routine_dbreindex.sql.txt (9,577); dsp_routine_dbreindex_sub.sql.txt (7,508); dsp_routine_deldddt.sql.txt (17,868); dsp_routine_deldddt_sub.sql.txt (3,827); dsp_routine_eodsetdd.sql.txt (1,546); dsp_routine_msdb_hkeep.sql.txt (2,485); dsp_routine_recsetdd.sql.txt (2,380); dsp_recsetdt.sql.txt (2,410); dsp_routine_restore_standby.sql.txt (12,938); dsp_routine_script_master.sql.txt (27,897); dsp_routine_sp_recompile.sql.txt (3,936); dsp_routine_unzpdddt.sql.txt (7,209); dsp_routine_update_stats.sql.txt (3,863); dsp_routine_yyyymmdd_hhmi.sql.txt (2,068); dsp_routine_zip_list.sql.txt (6,989); dsp_routine_zpncpydddt.sql.txt (23,543); sp_dba_fileusage.sql.txt (10,023); sp_dba_hexadecimal.sql.txt (1,114); sp_dba_rbldindex.sql.txt (27,551); and sp_dba_spaceused.sql.txt (6,567). The computer program listing appendix is hereby expressly incorporated by reference in the present application.

### FIELD OF THE INVENTION

This invention generally relates to data processing for database and file management or data structures, and in particular it relates to database or file management involving recoverability, archiving and backup.

### BACKGROUND OF THE INVENTION

Within distributed networking environments, there is a need for a consistent database infrastructure in order to properly maintain and backup data that may be stored in diverse network locations, particularly as the number of databases and servers in the networking environment increases. A lack of consistency and standards typically results in undue difficulty and expense, increases the rollout time for commissioning new database servers, and jeopardizes an organization's ability to restore critical data in the event of a failure of one or more network servers.

Various database management programs each offer a variety of software-enabled tools to assist database or network administrators in maintaining critical data. However, each has certain limitations that do not satisfactorily address the ability to safeguard data maintained in diverse file infrastructures, particularly with respect to databases stored in varying file formats and/or physically separate locations, as well as those stored under non-uniform file naming conventions.

MICROSOFT SQL SERVER is one commonly used database management program that is manufactured by MICROSOFT CORPORATION. It features Structured Query Language (SQL) functionality, database management, data analysis, and development tools that are highly scalable and are available for data stored in one or more networks and the Internet. The “sqlmaint” and log-shipping functions offered therein are useful for addressing certain database management needs. However, and particularly with respect to prior versions of SQL SERVER, each of these functions have certain limitations. For example, prior “sqlmaint” functions do not readily support full use of Database Consistency Checker (DBCC) functions, automatic scanning of SQL output files for errors, or support for striped backups. Log-shipping functions do not readily support event-based restoring of database transaction logs or a definable set of transaction logs, shipping of full database backups, or integration with various third party output and server checking programs.

Accordingly, there is a need for a method and apparatus for automated redundant data storage of data files maintained in diverse file infrastructures, which addresses certain limitations of prior technologies.

### SUMMARY OF THE INVENTION

It is an object of the present disclosure, therefore, to introduce processes for automated data backup and recovery implemented by one or more software components and automatically performed by a computer. The processes include dynamically generating programming strings, such as SQL query strings, that identify each database for a scheduled backup from a system table; and executing the scheduled backup of each identified database using the programming strings, thereby generating new database backup files and new backup transaction logs. The processes further confirms that the executed scheduled backups were completed and update a database that maintains a status of the scheduled backup. Recovery information for designated databases is generated with the executed scheduled backup.

The processes further dynamically generate and execute batch files that delete any existing database backup files and backup transaction logs that are outside a predetermined retention period or exceed a set number of logical generations of backups; assign a name to the new backup files and the new transaction logs based on an established naming convention; and copy the new backup files and the new transaction logs to a backup server.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a schematic diagram of an exemplary network over which the processes of the present disclosure may be performed;

FIGS. 2-6 are flow charts depicting an exemplary backup maintenance routine performed by a network server over the network of FIG. 1;

FIGS. 7-8 are flowcharts depicting an exemplary recovery set backup routine performed by the network server over the network of FIG. 1;

FIGS. 9-11 are diagrams depicting exemplary timelines at which the processes of FIG. 2-8 may be performed;

FIGS. 12-13 are flowcharts depicting an exemplary restore routine performed by a network server over the network of FIG. 1; and

FIG. 14 is a diagram depicting an exemplary timeline for performing the process of FIGS. 12-13.

### DETAILED DESCRIPTION OF THE SPECIFIC EMBODIMENTS

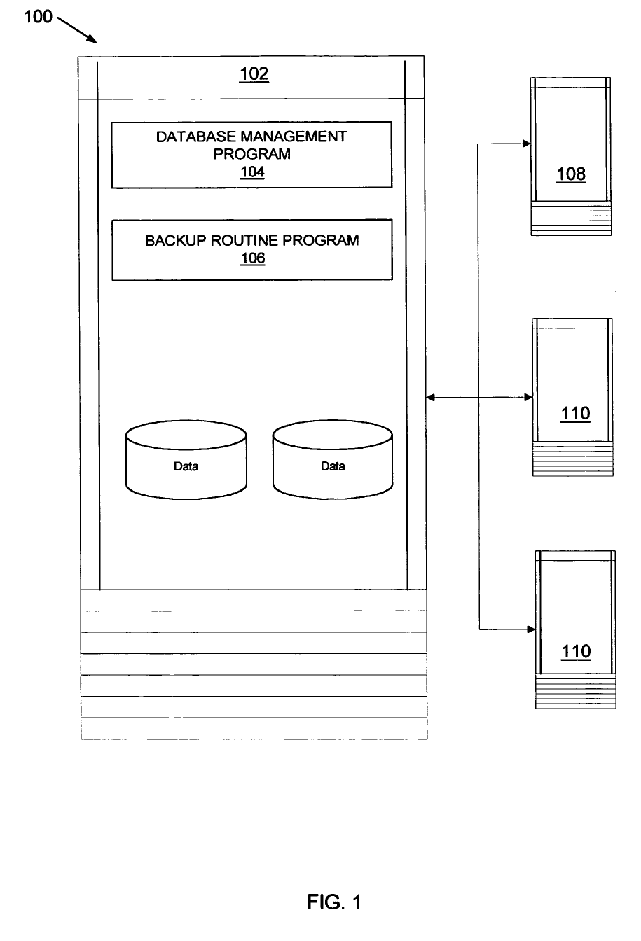

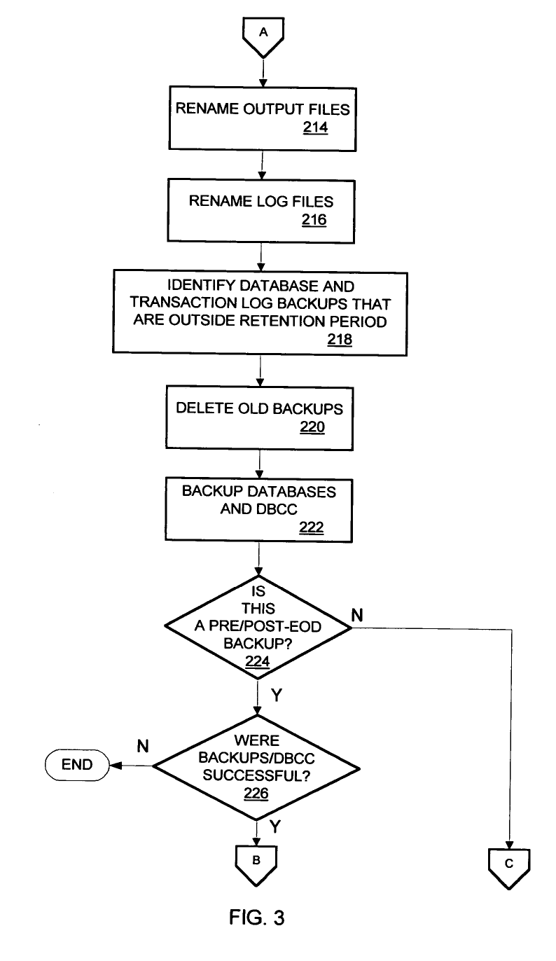

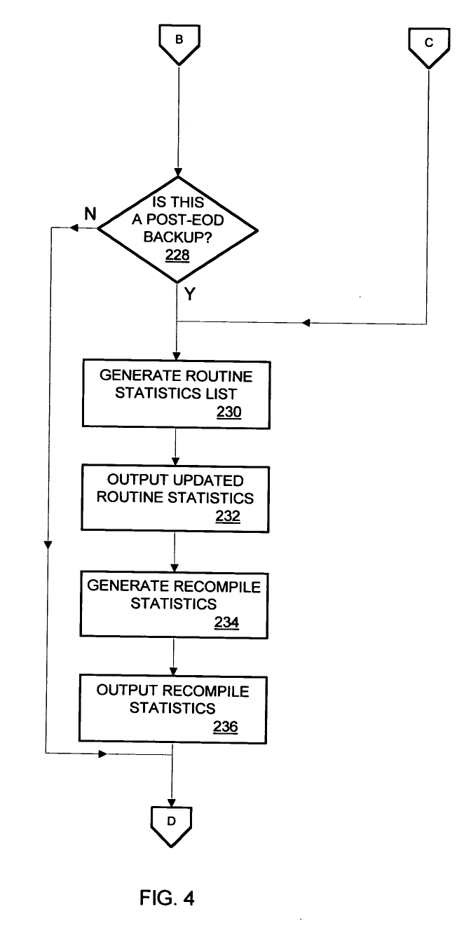

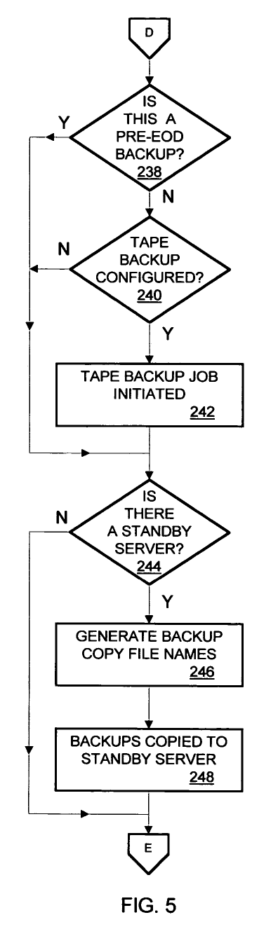

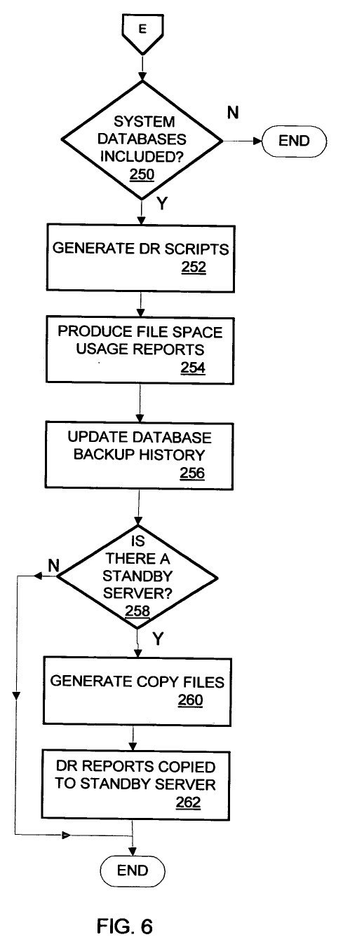

Referring now to FIGS. 1-14, wherein similar components of the present disclosure are referenced in like manner, various embodiments of a method and system for automated redundant data storage of data files maintained in diverse file infrastructures will now be described in detail.

The processes of the present disclosure address, in particular, various problems in coordinating database backup procedures in a multi-server corporate network environment, but may be readily adapted to computer networks of various sizes and configurations. As the number of servers grows in such environments, limitations with various database management programs (such as prior versions of MICROSOFT SQL SERVER) fail to meet certain database administration needs. For example, there are no standardized tools provided to address DATABASE CONSISTENCY CHECKER (DBCC) contention problems when it is run with on-line usage or against a live (rather than static) database. Additionally, there are no provisions for handling multi-database applications that require parallel backup supported by serial backup at off-peak hours.

The processes introduced herein use a number of programming techniques embodied in cooperative software components that provide an automated, re-usable, and configurable tool for database administration. The processes are generally configured to automatically run scheduled database backups based on system table entries, execute DATABASE CONSISTENCY CHECKER (DBCC) commands for checking the logical and physical integrity of databases in the scheduled backups, update and report on database backup and recovery statistics, and provide database index recompile functions so that queries can be continually re-optimized. Recovery set routines described herein readily support parallel multi-database backups. Parameterization options allow maintenance tasks to be switched on and off at the database level. Striping of backups (up to 99 stripes for database backup) are likewise supported.

Turning now to FIG. 1, there is depicted an exemplary computer network 100, over which the processes of the present disclosure may be implemented. The computer network 100 may be any type of known computer environment, including but not limited to a local area network (LAN), a wide-area network (WAN), a corporate intranet or extranet. The network 100 may likewise include any one or more components of a wired network, a wireless network, an optical network, a telecommunications network, or the like.

In the embodiments described herein, the computer network 100 will be described in the context of a central database backup server 102 in communication with at least one remote server 108 (containing databases to be included in a backup), and one or more standby backup servers 110 (for redundantly storing specified backup information or for warm standby operation). Each of these servers may be any known suitable type of computing device, including, but not limited to, an enterprise network server of the type commonly manufactured by IBM. Each of the servers may likewise include a single server or may be a group of distributed cooperating servers. It should be readily appreciated that any number of servers may be provided in the network 100, and that the example in FIG. 1 is not intended to be limiting with respect thereto.

In addition, the computer network 100 may include a variety of backup devices (not shown), such as tape backups, or other known large-scale storage devices, preferably having re-writable memory or media. The backup devices may be stand-alone and independently addressed or may be controlled by the remote server 108.

In addition to standard operating system and necessary application software, the central backup server 102 in the embodiments herein may store a database management program 104, such as SQL SERVER by MICROSOFT CORPORATION, and a backup routine program 106 which implements the processes of the present disclosure. The central backup server 102 may also store a system table that includes entries of databases and other files to be included in various scheduled backups. The entries in the table may be updated manually a database administrator (DBA) or other responsible personnel. In certain embodiments, the entries may be automatically updated by scanning remote servers for files conforming to a certain naming convention or that are stored on recognized remote servers having standardized file directory structures, as described later below. The use of a system table in this manner reduces the time needed to add or remove databases or other files to a backup, and reduces the time needed to configure new servers that may be added to the network 100 subsequent to the installation and initial execution of the processes presently disclosed.

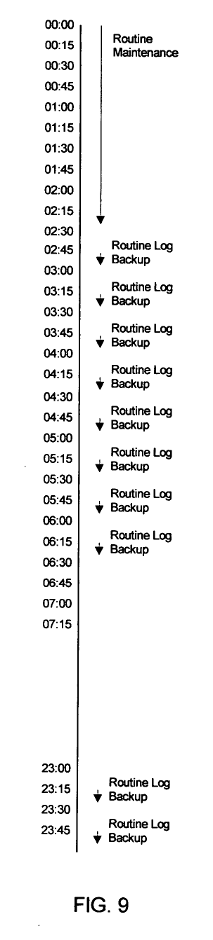

The backup routine program 106 as introduced herein executes various backup routines according to a desired schedule, as may be established by a DBA or other responsible personnel. FIGS. 9-11 and 14 depict exemplary timelines for scheduling of the backups. Each scheduled backup may include differing databases or other files for backup, the preference for which may be entered into the system table by a DBA or the like. Scheduled backups may include recovery set backups (i.e., those requiring parallel, multi-database backups). Scheduled backups may also include frequent routine maintenance programs that intermittently backup designated databases and transaction log files at relatively frequent intervals (i.e., every hour). Scheduled backups may also include pre-end-of-day (EOD) backup, EOD backup and post-EOD backup and housekeeping processes that, for example, run once daily and are more comprehensive than the routine maintenance program. Such daily processes are typically highly important to ensure proper data recovery, as is well known in the art.

In one exemplary embodiment, the processes of the database backup routine 106 are organized into three programming components. A Database Maintenance Component performs the following general automated functions: (1) housekeeping of database and transaction log backups; (2) initiating scheduled database backups based on system table entries; (3) invoking DBCC integrity check functions; (4) updating database maintenance statistics; (5) re-compiling databases and transaction logs; (6) compressing and copying of database backup to standby servers (where applicable); (7) producing database recovery (DR) scripts; and (8) producing summarized ‘errorlog’ files relating to the same.

A Transaction Log Component performs the following general automated functions: (1) transaction log backups; (2) compressing and copying transaction log backup files to standby servers (where applicable); and (3) producing summarised errorlog files relating to the same.

A Restore Component performs the following general functions when invoked: (1) uncompressing database and transaction log backups; (2) restoring database and transaction log backups; and (3) producing summarised errorlog files relating to the same.

In certain embodiments described herein, only a single instance of each of these components may run per SQL instance, in order to avoid possible errors and programming conflicts.

In the embodiments described herein, these programming components incorporate four general programming techniques by which batch files and interactive ISQL or OSQL calls contain parameterised procedures that are dynamically built based on variables and system table entries present at the time of a scheduled backup. Accordingly, no hard-coding of parameters is required, and the processes may run continuously and largely autonomously according to the schedule of backups.

According to the first general programming technique, a system table is maintained listing all database and other files to be included in various scheduled backups. The system table entries allow databases to be turned on and off individually for any scheduled backup, if desired.

According to the second general programming technique, SQL strings used to execute a scheduled backup are dynamically built based on the entries of the databases and other files in the system table.

According to the third general programming technique, interactive SQL calls are used to generate SQL work files (in .sql format) and SQL output files (in text format). The SQL work files execute further processes related to the scheduled backup, and the output files may be used to generate reports, update transaction logs and update backup statistics as desired.

According to the fourth general programming technique, interactive SQL calls are used to generate and execute batch (.bat) work files to coordinate the operation of the interactive SQL calls and dynamically built SQL scripts and batch output files (in text format) for reporting the result of these operations.

One embodiment of the three programming components has been provided in the accompanying computer program listing appendix incorporated herein by reference. The files have been provided in ASCII format with .txt extensions as required. The files are meant to be executable when provided without the .txt file name extensions and so such extensions will not be referenced hereinafter. Certain of the files identified below are shared by more than one of the programming components.

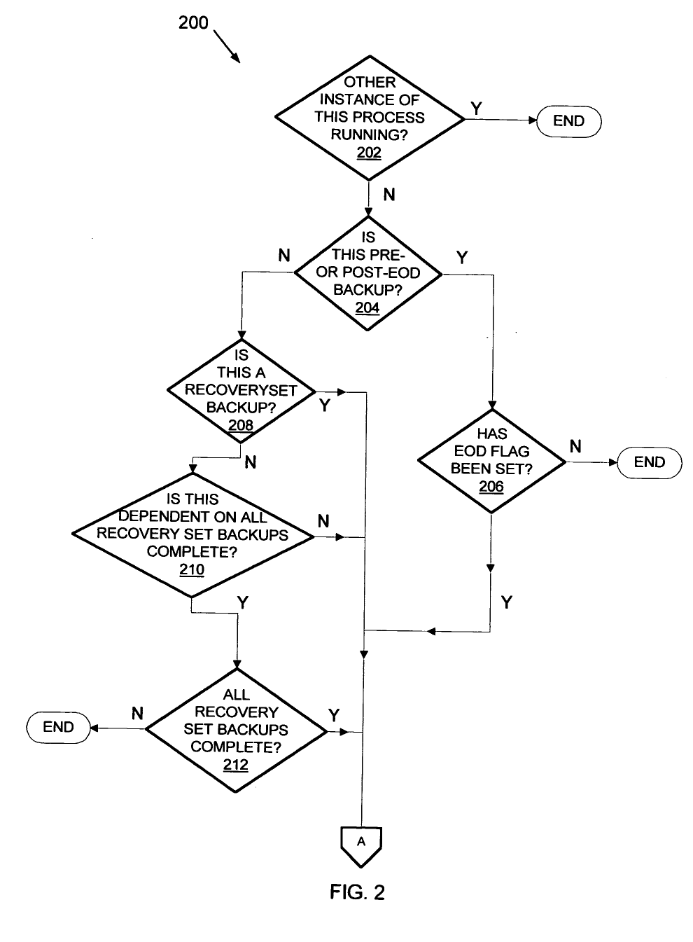

The Database Maintenance Component, in the exemplary embodiments particularly described herein, may include the following files from the computer program listing appendix: routine.bat; routparm.bat; routapp.bat; routerr.bat; routren.bat; dsp_routine_arcserve.sqt; dsp_routine_backdbcc.sql; dsp_routine_chkpsteod.sqt; dsp_routine_copyfiles.sql; dsp_routine_dbackeod.sql; dsp_routine_dblist.sql; dsp_routine_dbreindex.sql; dsp_routine_dbreindex_sub.sql; dsp_routine_deldddt.sql; dsp_routine_deldddt_sub.sql; dsp_routine_eodsetdd.sql; dsp_routine_msdb_hkeep.sql; dsp_routine_recsetdd.sql; dsp_routine_script_master.sql; dsp_routine_sp_recompile.sql; dsp_routine_update_stats.sql; dsp_routine_yyymmdd_hhmi.sql; dsp_routine_zpncpydddt.sql; sp_dba_fileusage.sql; sp_dba_hexadecimal.sql; sp_dba_rbldindex.sql; and sp_dba_spaceused.sql. Routine.bat is the core of the Database Maintenance Component and may be run by the central database server 102. The remaining files identified above are called by routine.bat to cooperatively perform the functions described below with respect to FIGS. 2-14.

The Transaction Log Component in the embodiments described herein may include the following files from the computer listing appendix: routtran.bat; routapp.bat; routerr.bat, routren.bat; dsp_routine_backlog.sql; dsp_routine_dbackeod.sql; dsp_routine_dblist.sql; dsp_recsetdt.sql; dsp_routine_yyyymmdd_hhmi.sql; and dsp_routine_zpncpydddt.sql. Routtran.bat is the core of the Transaction Log Component and may be run by the central database server 102. The remaining files are called by routtran.bat to cooperatively perform the functions described immediately below and later with respect to FIGS. 2-14.

Backup paths and file names may be dynamically built by the components from entries in the system table (i.e. database or other file names) and the current date/timestamp. Examples of backup file names that may be generated include:
(a) dd_databasename_yyymmdd_hhmi_xxx_mm-nn.bak; or
(b) dd_databasename_yyyymmdd_hhmi_xxx_mm-nn_ppp_eod.bak
   where:
      dd (first instance)=‘dd’
      databasename=name of corresponding database being backed-up
      yyyy=current year
      mm=current month
      dd (second instance)=current day
      hh=current hour
      mi=current minute
      xxx=‘bak’ for a full datatabase backup
         =‘dif’ for a differential database backup,
         =‘txn’ for a transaction log backup
      mm=numeric 01 to 99, which represents the stripe number of an individual stripe
      nn=numeric 01 to 99, which represents the number of stripes in a stripe set
      ppp=‘pre’ or ‘pst’
      eod=‘eod’
      bak=‘bak’

Example of standardized names of full backup with three stripes:
dd_mydb_{—}20040521_{—}0932_bak-01-03.bak
dd_mydb_{—}20040521_{—}0932_bak-02-03.bak
dd_mydb_{—}20040521_{—}0932_bak-03-03.bak

Example of standardized name of transaction log backup:
dd_mydb_{—}20040521_{—}0932_txn-01-01.bak

Example of standardized names of differential pre-eod backup with 12 stripes:
dd_mydb_{—}20040521_{—}0932_dif-XX-12_pre_eod.bak (where ‘XX’=values ‘01’ through ‘12’ for the respective stripes).

Compression may be accomplished using, for example, WINZIP or PKZIP. The compressed copy files are then copied to the standby server 10 (step 248) using, for example, NT COPY, MIDDLEWARE MQCP, ROBOCOPY, or any other known programs of similar functionality. All transaction log backups zipped and copied with each scheduled backup. However, it is possible to exclude individual databases from compression and copying by appropriate entries in the system table. Upon completion of compression and copying a flag on standby server is set by the Transaction log Component to signify successful completion of functions in the scheduled backup.

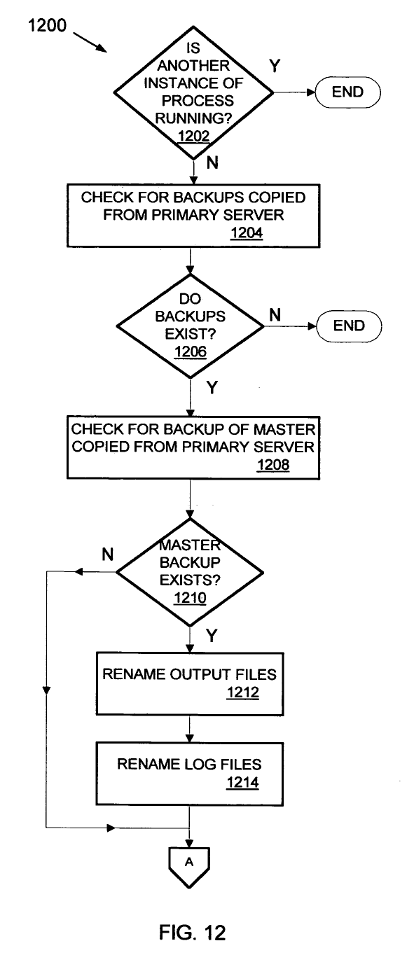

The Restore Component in the exemplary embodiments described herein may include the following files from the computer listing appendix: routdel.bat; routload.bat; routpars.bat; routapp.bat; routcon2.bat; routerr.bat; rouren.bat; dsp_routine_chkforzips.sql; dsp_routine_dbackeod.sql; dsp_routine_deldddt.sql; dsp_routine_deldddt_sub.sql; dsp_routine_restore_standby.sql; dsp_routine_unzpdddt.sql; dsp_routine_yyyymmdd_hhmi.sql; and dsp_routine_zip_list.sql. Routload.bat is the core of the Restore Component and may be run by one or more of the standby servers 110 in the event data recovery is needed. The remaining files are called by routload.bat to cooperatively perform the functions described immediately below and later with respect to FIGS. 12-14.

Uncompress and restore functions are handled primarily by the Restore Component and may be manually initiated in the event data recovery is needed. By default, all compressed databases and files will be restored when needed, however it is possible to exclude individual databases and files by appropriate entries in the system table. The Restore Component also performs housekeeping functions for all generations of database backups and all transaction logs retained.

It is contemplated that for the specific embodiments of the Database Maintenance, Transaction Log and Restore Components described herein, there exist standardized naming conventions applied to work files and output files generated by the disclosed processes. One advantage of the naming convention is the automated recognition of certain files based on their standardized name, or the standardized directory in which they are stored. Naming conventions further allow one error checking script (i.e., routerr.bat) to be used for all servers in the network 100.

One set of naming conventions is provided as follows, however, it should be readily appreciated that other file or directory naming standards may be used:
(a) Backup files on primary server may be kept in a path relative to:
   (1) \mssql$instance\backup—for a named instance
   (2) \mssql\backup—for a default instance
(b) Backup files for restore on standby server may be kept in a path relative to:
   (1) \mssql$instance\standby—named instance
   (2) \mssql\standby—default instance
(c) System and dba_status backup files relative paths:
   (1) .\DBA\bak—database backups and zip files
   (2) .\DBA\txn—transaction log backups and zip files
   (3) .\DBA\do_not_delete—backups here are ignored by housekeeping
(d) Relative paths for application backup files (where ‘applid’ is the application identifier):
   (1) .\applid\bak—database backups and zip files
   (2) .\applid\txn—transaction log backups and zip files
   (3) .\applid\do_not_delete—backups here are ignored by housekeeping
   (4) .\applid\sbf—standby file (Standby Server only)
(e) Files for Disaster Recovery may be kept in a path relative to:
   (1) \DRA$instance—named instance
   (2) \DRA—default instance
(f) Relative paths for various file types:
   (1) in the base directory for batch files and associated scripts
   (2) .\Log—for log files output from run of each script (log files may be named according to certain parameters passed).
   (3) .\Work—for temporary work files created by scripts
   (4) .\Output—for output from scripts
   (5) .\master—for output from script to generate contents of master database and configurations
   (6) .\Recovery—for scripts to reload DBA procedures
   (7) .\Sql_Procs—for source code of DBA procedures
(g) Script files may be kept in a path relative to:
   (1) \Routine$instance—for named instance on primary server (i.e., backup server 102)
   (2) —Routine—for default instance on primary server
   (3) \Routins$instance—for named instance on standby server
   (4) \Routins—for default instance on standby server
(h) Database backup files may be named as follows (where ‘dbname’ is name of the database in recovery set):
   (1) routine.log—backup of all non-recovery set databases
   (2) routine_dbname_log—backup of recovery set database
   (3) routine_dbname_pre_eod.log—pre end-of-day backup of recovery set database
   (4) routine_dbname_pst_eod.log—post end-of-day backup of recovery set database
(i) Transaction log backup files may be named as follows (where ‘dbname’ is name of database in recovery set):
   (1) routtran.log—backup of all non-recovery set databases
   (2) routtran_dbname_log—backup of recovery set database
   (3) routtran_dbname_pre_eod.log—pre end-of-day backup of recovery set database
   (4) routtran_dbname_pst_eod.log—post end-of-day backup of recovery set database
(j) Database restore files may be named as follows:
   (1) routload.log—for restore information of all databases
   (2) routload_dbname.log—for restore information of an individual database (where ‘dbname’ is name of the individual database)
(k) Output files may be named as follows (where ‘filename’ is specific to the job step):
   (1) filename.txt—all non-recovery set databases
   (2) filename_dbname.txt—recovery set database
   (3) filename_dbname_pre_eod.txt—recovery set database pre end-of-day
   (4) filename_dbname_pst_eod.txt—recovery set database post end-of-day where ‘filename’ has the following possible values:
      (A) backdbcc—for database backup and DBCC files
      (B) backtran—for transaction log backup files
      (C) copyfiles—for copy of DR files to standby server
      (D) deldddt—for housekeeping of backups
      (E) errormsg—for results of scan of output files
      (F) recomp—for sp_recompile functions
      (G) routrstr—restore of database on standby server
      (H) stats—for updated statistics
      (I) unzpdddt—for unzip of backups on standby server
      (J) zpncpydd—for copy of database backups to standby server
      (K) zpncpydt—for copy of transaction log backups to standby server.

Referring now to FIGS. 2-6, therein are depicted flow charts showing an exemplary backup maintenance routine 200 performed, for example, by the network server 102 over the network 100 of FIG. 1. The process 200 is instantiated for any of the scheduled backup routines described herein, including pre-EOD backups, EOD backups, post-EOD backups or intermediate routine maintenance backups of databases and transaction logs. Each of these particular backup routines may be executed according to the timing diagrams of FIGS. 9-11 below.

The Database Maintenance Component including the routine.bat file as provided in the computer program listing appendix are one set of possible programming instructions for accomplishing the process 200. The routine.bat file may be executed manually or may be automatically run for the following maintenance scenarios according to a desired schedule: (a) for all non-recovery set databases on the server 102, where backups are not copied to a standby server 110; (b) for all non-recovery set databases on the server 102, where backups are copied to a standby server 110; (c) for all non-recovery set databases on the server 102, where backups are not copied to the standby server 110 and the run of this process is dependent upon the successful completion of all backups in a recovery set; (d) for all non-recovery set databases on the server 102, where backups are copied to the standby server 110 and the run of this process is dependent upon successful completion of all backups in a recovery set; (e) for a non-EOD database in a recovery-set, where backups are not copied to the standby server 110; (f) pre-EOD for an EOD database in a recovery-set, where backups are not copied to the standby server 110; and (g) pst-EOD for an EOD database in a recovery-set, where backups are copied to the standby server 110. Other scenarios are possible.

For each database designated for backup according to the system table, the routine.bat file automatically performs database backups, DBCC checks, updating of database maintenance and storage statistics, recompilation of database information, compression and copying of backup files to a standby server, housekeeping functions and generation of DR reports and recovery scripts for completed backups. This version of routine.bat requires up to nine parameters input by a DBA or the like or retrieved from the system table: (a) the drive letter where the \routine directory exists; (b) the directory on the drive where this file resides; (c) the name of the central backup server 102; (d) the login name used to connect to SQL Server; (e) the valid password of the login; (f) whether this run is linked to successful completion of recovery-set backups; (g) whether copies are to be sent to a standby server; (h) the name of the database to be backed up; (i) the run type for this instance (e.g., ‘pre_eod,’ ‘mid_eod,’ or ‘post_eod’).

These inputs may be entered immediately after manual activation of the routine.bat file, for example, by entering the following exemplary command line and parameters at the operating system level of the server 102:
routine e \routine$P1433 DBJCML06\P1433 dba_maint freddie nolink nostby
   Alternatively, the routine.bat file may be called at automated intervals with the parameters above retrieved from appropriate entries in the system table.

The process 200 commences with confirming that no other instances of the process 200 running on the server 102 (step 202). This may be accomplished in conjunction with the script dsp_routine_dbackeod.sql from the computer listing appendix. If another instance is already running, this second instance of the process 200 will terminate, and may resume after completion of the existing first instance.

If no other instances are running, the process 200 next identifies whether this instance is activated for a pre-EOD or post-EOD backup (step 204). The identification may be based on the current local server time and the type of scheduled backup designated for that time as stored, for example, in the system table. If this process is for a pre-EOD or post_EOD backup, the process 200 continues to step 206 below. If, instead, this instance is for other than a pre- or post-EOD backup, the process 200 continues to step 208, described later below.

From step 204 above, when the scheduled backup is a pre- or post-EOD backup, the process 200 executes a SQL script (i.e., dsp_routine_eodsetdd.sql) to set an EOD flag that will later allow a dependent EOD backup to run. This script also outputs update statistics for a transaction log, for example, by generating an output file (i.e., \routine\log\routine_%suffix%.log) named in accordance with the standard naming convention employed. (step 206), where‘_%suffix%’ has a value that is dependent on the type of run that is scheduled, such as:
_%suffix% is un-assigned when scheduled as Routine Maintenance;
_%suffix% is of the form “_database_name” when scheduled as Routine Backup of an individual database
_%suffix% is of the form “_database_name_runtype” when scheduled as Routine EOD backup, where ‘runtype’=‘pre_eod’ or ‘pst_eod’

If at step 206 the flag has been set, the process 200 continues to step 214 below, otherwise the process 200 terminates and a failure is reported.

Continuing from the previous step 204, when the scheduled backup is not a pre- or post-EOD backup, the process 200 instead continues to step 208 where it is determined whether the scheduled backup is a recovery set backup. If so, the process 200 continues directly to step 214 below. Otherwise the process 200 continues from step 208 to step 210 where it is determined whether this scheduled backup is dependent on prior recovery set backups being completed. If there is no dependency, then the process 200 continues to step 214 below.

Otherwise the process 200 continues to step 212 where it is determined whether the requisite prior recovery set backups have been completed. This may be accomplished, for example, by execute the script dsp_routine_recsetdd.sql; in which the transaction logs are scanned for confirmation of the requisite recovery set backups. If they have been completed, the process 200 continues to step 214, and if not the process 200 terminates and the failure is reported.

From any of steps 206, 208, 210 and 212 above, the process 200 continues to step 214 where previous generations of output files are renamed according to their scheduled backup performed and their date. This renaming may be accomplished, for example, by automatically executing the routren.bat file.

Next, at step 216, the previous generations of transaction log files are renamed. This may also be accomplished using the routren.bat file.

The process 200 then continues to step 218, where database and transaction log backups that are outside an established retention period (i.e., 2 days) or exceed a set number of logical backup-generations are identified. This may be accomplished by running the script dsp_routine_backdbcc.sql in conjunction with dsp_routine_deldddt_sub.sql and dsp_routine_yyymmdd_hhmi.sql.

Any backup files and transaction logs outside the retention period are then deleted automatically (step 220). This may be accomplished using the routdel.bat file.

Next, designated databases backups are performed followed by DBCC check of the success of the backups (step 222). This may be accomplished, for example, by the dsp_routine_backdbcc.sql script. Backup files are dynamically named according to the established naming convention, which may include identifiers such as ‘pre_eod’ and ‘pst_eod,’ where appropriate, and include the original database name as well as a yyyymmd_hhmi timestamp based on the local server time. Exemplary names include:
d??_database_name_yyyymmdd_hhmi.bak where ?=d, or 1 through 99 for striped backups
d??_database_name_???_eod_yyymmdd_hhmi.bak where ???=pre or pst
   DBCC checks run immediately after a backup is completed. It is possible to exclude individual databases from DBCC checks by manual entry of appropriate parameters or by entries in the system table. The DBCC checks may be implemented using the dsp_routine_dbreindex.sql and dsp_routine_dbreindex_sub.sql scripts.

Next, at step 224, if the process 200 is a pre- or post-EOD backup, the process 200 continues to step 226 as follows. Otherwise, it continues to step 232 later below.

Next, at step 226, the process 200 confirms that the backups and DBCC checks were successful. This may be accomplished, for example, by the dsp_routine_chkpsteod.sql script. If there are no errors, the process 200 continues as follows. Otherwise, the process 200 ends and a report of the error is generated.

Next, at step 228, if the scheduled backup is a post-EOD backup, the process 200 continues to step 230 immediately below. Otherwise, the process 200 continues at step 238 later below.

At step 230, database statistics for the backups are generated, This may be accomplished, for example, by the dsp_routine_update_stats.sql script. In normal operation, all requested statistics will be reported for all databases subject to the backup. However, it is possible to exclude individual databases by appropriate entries in the system table.

Next, at step 232, the updated routine statistics are output to an output file, after which recompile statistics are generated (step 234). This may be accomplished, for example, by the dsp_routine_sp_recompile.sql script. The recompile statistics are then established in the same or another output file (step 236).

From step 236, it is next determined if this process if for a pre-EOD backup (step 238). If so, the process 200 continues to step 244, later below. Otherwise, it continues as follows.

Next, at step 240, the process determines from entered parameters or system table entries whether a tape backup (or backup to other media-based device) is configured. If so, the process continues to step 242 below. Otherwise, the process continues to step 244 later below.

At step 242, the tape backup jobs is initiated. This may be accomplished, for example, by using the dsp_routine_arcserve.sql script.

Next, at step 244, the process 200 determines whether a copy of the backup is to be sent to a standby server. If so, and if the standby server is available, the process continues to step 246 below. Otherwise, the process 200 continues to step 250 later below.

At step 246, backup copy files are generated and compressed. This may be accomplished, for example, using the dsp_routine_zpncopydddt.sql script. Compression may be accomplished using WINZIP or PKZIP. The compressed copy files are then copied to the standby server 10 (step 248) using, for example, NT COPY, MIDDLEWARE MQCP, or ROBOCOPY.

Next, at step 250, the process 200 determines whether a scheduled backup of system databases is included? If so, the process continues to step 252, immediately below. Otherwise, the process 200 ends.

At step 252, DR scripts are generated. This may be accomplished, for example, using the dsp_outine_script_master.sql script in conjunction with the sp_dba_hexadecimal.sql script. The script sp_dba_fileusage.sql may also be used to report device allocations by database for DR purposes.

Next, at step 254, the proess 200 produces a file space usage report. This may be accomplished, for example, by invoking the sp_dba_fileusage.sql script. A space monitoring report may also be produced, for example, by using the sp_dba_spaceused.sql script.

Next, at step 256, standard housekeeping functions are performed regarding the database backup history. This may be accomplished, for example, by using the dsp_routine_msdb_hkeep.sql script. The housekeeping functions ensure, inter alia, that only a certain number of generations of backup data are currently being maintained.

The process 200 then continues to step 258, where it is determined whether the reports above are to be copied to a standby server available. If so, and if the standby server is available, the process 200 continues to step 260, immediately below. Otherwise, the process 200 terminates.

Next, copy files of these DR reports are generated (step 260) and copied to a designated standby server 110 (step 262). this may be accomplished, for example, using the dsp_routine_copyfiles.sql script. The process 200 then terminates until its next instantiation.

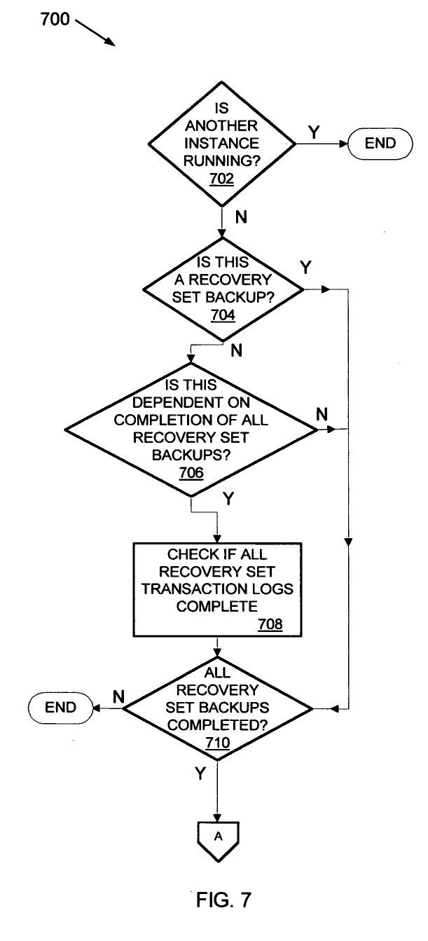

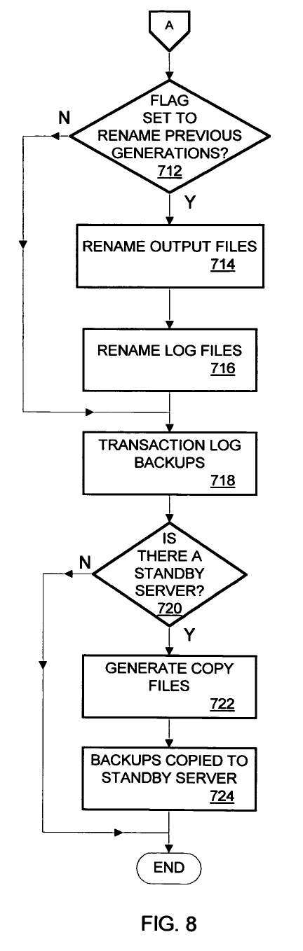

FIGS. 7-8 are flowcharts depicting an exemplary transaction log backup routine 700 performed by the network server 102 over the network 100 of FIG. 1. The batch file routtran.bat and associated batch and SQL scripts of the Transaction Log Component, are one example of programming instructions that may be used to accomplish the process 700 over the network 100.

The process 700 commences with confirming that no other instance of the process is running (step 702). If there is another instance running, the process 700 ends. Otherwise, the process 700 continues in the following manner.

Next, at step 704, the process 700 determines whether this is a recovery set backup, based on parameters set manually or by entries in the system table. If this is for a recovery set, the process 700 continues to step 712, below. If this is not for a recovery set, the process 700 continues as follows.

Next, the process 700 determines whether this recovery set is dependent on previous recovery set backups being successfully completed (step 706). If not, the process 700 continues to step 712 below. If this process 700 is instead dependent on the successful completion of other recovery set backups, the process 700 confirms that all transaction logs for the recovery sets are complete (step 708). This may be accomplished, for example, by executing the dsp_routine_recsetdt.sql script.

Next, at step 710, if all recovery set backups complete, the process 700 continues to step 712, and otherwise the process 700 terminates.

Continuing from either step 704 or 710 above, the process 700 next confirms whether a flag has been set by previous processes, which allows the renaming of previous generations of output files and transaction logs (step 712). If the flag has not been set, the process continues to step 718 later below. If, on the other hand, the flag has been set, the process 700 instead continues in the following manner.

From step 712, the process 700 next initiates the renaming of previous generations of output files (step 714) and transaction log files (step 716). These steps may be accomplished, for example, using the routren.bat file.

Next, at step 718, transaction log backups are completed. this may be performed, for example, by initiating the dsp_routine_backlog.sql and dsp_routine_dblist.sql scripts.

Next, at step 720, the process 700 determines whether a standby server has been designated to receive the transaction log backups. If not, the process 700 terminates. Otherwise, the process 700 continues as follows.

At step 722, copy files are generated for the standby server and compressed. This may be accomplished, for example, by using the dsp_routine_zpncpy.dddt.sql script. The backups are then backups copied to standby server (step 724), after which the process 700 ends.

FIGS. 9-11 are diagrams depicting exemplary timelines at which the processes 200 and 700 of FIG. 2-8 may be performed. FIG. 9 depicts one exemplary timeline of scheduled routines performed by the server 102, in which there is no recovery set backups. Only those runs that perform transaction log backups are shown on this diagram. In this example, Routine Maintenance runs once (for example, at midnight local server time). Routine Log Backup checks on the 1/4 hour and 3/4 hour to see if Routine Maintenance is running, and only runs when Routine Maintenance isn't running.

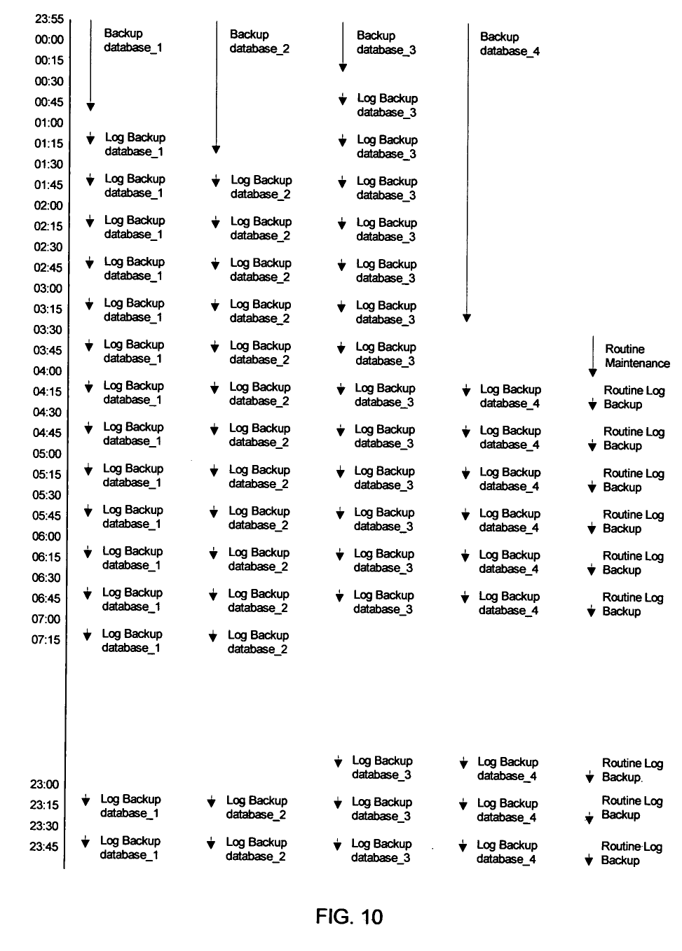

FIG. 10 depicts a timeline for performing recovery set backups. In this example, Routine Maintenance can be configured to check on the hour and 1/2 hour to see if all recovery set backups have completed and to only run when this is true. It can also be configured to run once per day independent of whether the recovery set backups have completed. Routine Log Backup can be configured to check on the 1/4 hour and 3/4 hour to see if Routine Maintenance and all recovery set transaction log backups have completed. It can also be configured to run once per day independent of whether the recovery set transaction log backups have completed. It only runs when Routine Maintenance isn't running and all the logs have been dumped. Log Backup checks every 18 and 48 minutes past the hour to see if Routine Backup is running.

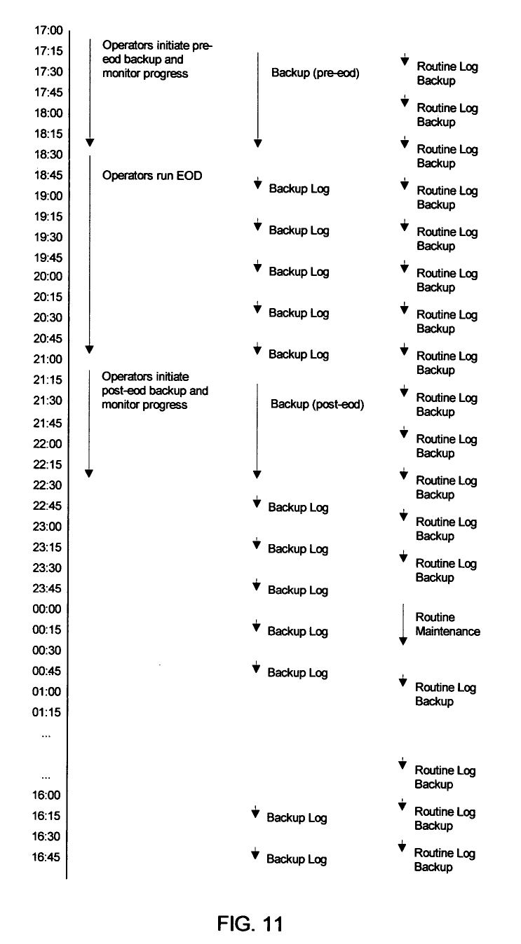

FIG. 11 is a diagram depicting an exemplary timeline for performing pre-EOD, EOD and post-EOD processes. In this exemplary timeline, Routine Maintenance can be configured to check on the hour and 1/2 hour to see if all recovery set post-EOD backups have completed and to only run when this is true. It can also be configured to run once per day independent of whether the recovery set backups have completed. Routine Log Backup can be configured to check on the 1/4 hour and 3/4 hour to see if Routine Maintenance and all recovery set transaction log backups have completed. It can also be configured to run once per day independent of whether the recovery set transaction log backups have completed. Routine Log Backup only runs when Routine Maintenance isn't running and all the logs have been dumped. Only the runs which perform log dumps are shown on this diagram. Log Backup checks every 18 and 48 past the hour to see if Routine Backup is running. Only the runs which perform transaction log backups are shown on this diagram.

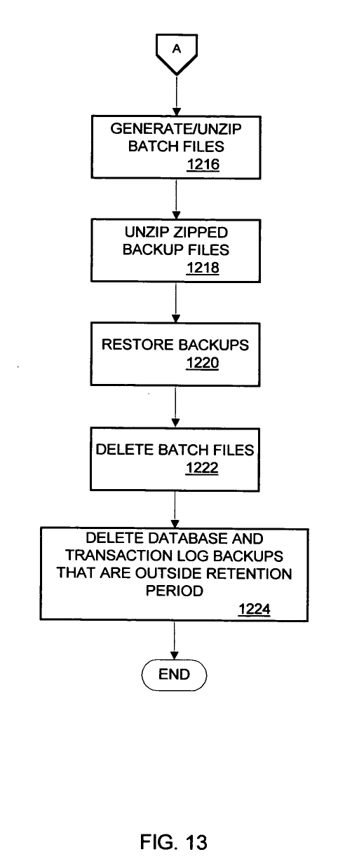

FIGS. 12-13 are flowcharts depicting an exemplary restore routine 1200 performed by a standby server 110 over the network 100 of FIG. 1. The routload.bat file and other files listed below as provided in the computer program listing appendix may be used to accomplish the functions of the restore process 1200.

The restore process 1200 commences with a determination of whether another instance of this process running (step 1202). If so, this instance terminates. Otherwise, the process 1200 continues as follows.

The standby server 110 next checks for recent backup file and transaction logs copied from the server 102 (step 1204). This may be accomplished, for example, by running the script dsp_routine_chkforzips.sql.

If, at step 1206, such backups exist, the process continues to step 1208 as follows. If, on the other hand, no backups exist, the process 1200 terminates. In such event, the script sp_dba_rbldindex.sql script may be run manually by a DBA, or other responsible personnel, to rebuild the index of backups requiring the restore.

Next, at step 1208, the process 200 determines whether master backups have been copied from the server 102. this again may be accomplished using the script dsp_routine_chkforzips.sql. If, at step 1210, the master backups exist, the process 1200 continues to step 1212 below. Otherwise, the process 1200 continues to step 1216 described later below.

Previous generations of output files (step 1212) and transaction logs (step 1214) in the master backup are next renamed in accordance with the established naming conventions. This may be accomplished using the routren.bat file. The process 1200 then continues to step 1216 of FIG. 13.

The standby server next uncompresses batch recovery files (step 1216), as well as backup files and transaction logs (step 1218). This may be accomplished, for example, using the dsp_routine_unzpdddt.sql and dsp_routine_zip_list.sql scripts.

The uncompressed files are then restored (step 1220). This may be accomplished using the dsp_routine_restore_standby.sql script.

After the restore is complete, the uncompressed batch recovery files (step 1222) and any uncompressed databases and transaction logs that are outside the retention period (step 1224) are deleted. This may be accomplished using the dsp_routine_deldddt.sql script.

The process 1200 then ends.

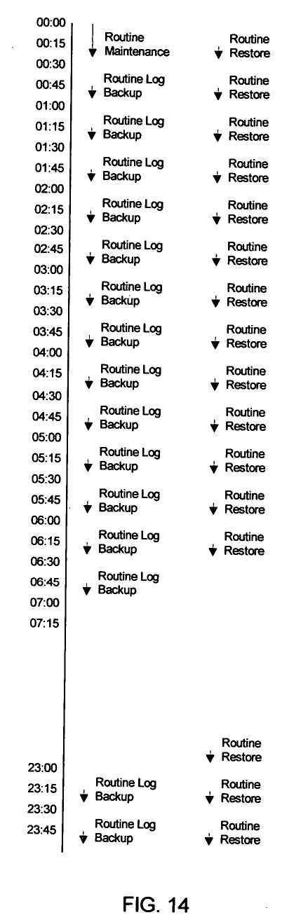

FIG. 14 is a diagram depicting an exemplary timeline for performing routines that support the recovery process of FIGS. 12-13, as performed, for example, by the standby server 110. Only the runs that perform transaction log backups are shown on this diagram. According to the timeline, Routine Maintenance runs once at midnight to back up the system and dba_status databases. Routine Restore checks on every 1/4 hour and 3/4 hour to determine whether Routine Maintenance is running properly. It only runs when Routine Maintenance isn't running. Routine Restore also runs every ten minutes and restores database backups and transaction log backups copied from the server 102.

It is readily contemplated that further features may be readily incorporated into the processes disclosed herein in any manner known to those of ordinary skill in the art. For example, it is contemplated that automatic server polling can be used for gathering daily database statistics. It is further contemplated that server checks may be integrated with a pager or other alert notification system that automatically messages a DBA or other responsible personnel upon identification of significant errors or failures. It is also contemplated that database backups and logs may be restored into multiple destination databases on the same SQL instance.

The processes disclosed herein support an automated backup monitoring component that allows all servers to be monitored with minimal effort. Additionally, database and server identification is simplified because all servers have standardized naming and directory conventions. These processes are therefore beneficial in closing gaps in DR capability by ensuring that there are no missed scheduled backups.

Although the best methodologies of the invention have been particularly described in the foregoing disclosure, it is to be understood that such descriptions have been provided for purposes of illustration only, and that other variations both in form and in detail can be made thereupon by those skilled in the art without departing from the spirit and scope of the present invention, which is defined first and foremost by the appended claims.

1. A method, performed by a server, for maintaining backup data in a computer network, comprising:
accessing a system table that identifies a plurality of databases;
generating dynamically-built query strings that identify each database for a scheduled backup from the system table;
executing programming scripts that are based on the dynamically-built query strings, the programming scripts for instructing the server to commence a scheduled backup of each identified database, thereby generating new database backup files; and
executing batch files for instructing the server to automatically copy the new database backup files to a backup server.

2. The method of claim 1, the databases comprising:
a first database stored at a first physical location and a second database stored in a second physical location.

3. The method of claim 1, the databases comprising:
a first database having a first file format and a second database having a second file format.

4. The method of claim 1, said batch files further for instructing the server to name the new backup files according to a predefined naming convention, in which at least a date of the completed scheduled backup is indicated in the name.

5. The method of claim 4, the naming convention further including at least one of
an indication of an original file name of the database, and a time of the completed scheduled backup.

6. The method of claim 1, the batch files further for instructing the server to:
delete any old database backup files that are outside a predetermined retention period or that exceed a set number of logical backup generations.

7. The method of claim 1, the backup server comprising at least one of a primary backup server and a standby server.

8. The method of claim 1, the query strings comprising Structured Query Language (SQL) strings.

9. The method of claim 8, the programming scripts comprising SQL scripts.

10. The method of claim 9, wherein the SQL scripts and batch files are executed via interactive SQL calls.

11. The method of claim 1, the batch files further for initiating at least one database backup to an external media backup device.

12. The method of claim 1, the batch files further for instructing the server to compress the new backup files.

13. The method of claim 12, the batch files further for instructing the server to:
expand all compressed new backup files during a recovery of the new backup files.

14. The method of claim 1, the scheduled backup consisting of an end-of-day (EOD) backup, the programming scripts further for instructing the server to:
confirm that any previous required backups have been completed, prior to commencing the EOD backup.

15. The method of claim 14, the scheduled backup consisting of other than an end-of-day (EOD) backup, the programming scripts further for instructing the server to:
indicate whether the scheduled backup has been completed, wherein a subsequent EOD backup may only be completed when such indication is affirmative.

16. The method of claim 1, the batch files further for instructing the server to:
generate recovery set information for any designated databases in the scheduled backup.

17. The method of claim 1, wherein the new database files include new transaction logs.

18. The method of claim 1, wherein the query strings identify all databases having file names with a predetermined set of characters dynamically assigned by the batch files.

19. A method, performed by a processor, for maintaining backup data in a computer network, comprising:
accessing a table that identifies a plurality of databases;
generating query strings that identify each database from the table that are designated for a scheduled backup;
executing programming scripts that are based on the query strings, the programming scripts for instructing the server to commence a scheduled backup of each identified database, resulting in new database backup files and new database transaction logs, and
executing batch files for instructing the server to:
name the new database backup files and the new database transaction logs according to a naming convention; and
copy the new database backup files and the new database transaction logs to a backup server.

20. An apparatus for maintaining backup data in a computer network, comprising:
a processor; and
a memory in communication with the processor, the memory storing a plurality of programming scripts for instructing the processor to:
dynamically generate programming strings that identify each database for a scheduled backup from a system table;
execute the scheduled backup of each identified database using the programming strings, thereby generating new database backup files and new backup transaction logs;
confirm that the executed scheduled backup was completed;
update a status database that maintains a status of the scheduled backup;
generate recovery information for designated databases in the executed scheduled backup;
delete any existing database backup files and backup transaction logs that are outside a predetermined retention period or that exceed a set number of logical backup generations;
assign a name to the new backup files and the new transaction logs based on an established naming convention; and
copy the new backup files and the new transaction logs to a backup server.
